(19) United States
(12) Patent Application Publication
(10) Pub. No.: US 2009/0020541 A1
(43) Pub. Date: Jan. 22, 2009

(54) Self-cooling plastic drink bottle

(76) Inventor: Alan Joseph Bauer, Jerusalem (IL)

Correspondence Address: Dr. Alan Joseph Bauer, 49 Ussishkin, Jerusalem, 94542, IL

(21) Appl. No.: 11/826,411

(22) Filed: Jul. 16, 2007

(51) Int. Cl. A47J 41/00; B65D 1/04; B65D 25/04

(52) U.S. Cl. 220/592.17; 215/6; 220/524

(57) ABSTRACT

The present invention describes an improved plastic drink bottle. By preparing a drink bottle with separate closed internal compartments that allow for access to drinking fluids in one or both closed internal compartments, one may effectively cool beverages and supply more than one beverage in a single drink bottle.

### BACKGROUND OF THE INVENTION

1. Field of the Invention

The present invention provides for a plastic drink bottle and a disposable drink bottle that minimally include two distinct closed internal compartments that may be filled with drinking fluids. The bottle comes with two external caps or one internal cap that allows for user-controlled access to one or both of the drinking fluids. One may fill one of the closed internal compartments with a first drinking fluid and freeze said drinking fluid in a freezer. Adding a second drinking fluid to a second drinking compartment and joining closed internal compartments to form a single plastic drink bottle allows for cooling of second drinking fluid through its proximity to frozen first drinking fluid. After the first drinking fluid has thawed, it too may be imbibed. The frozen first drinking fluid cools the second drinking fluid while the second drinking fluid warms up the frozen first drinking fluid to allow for the latter's consumption after thawing. Together, the drinking fluids combine for an extended period of cold drink enjoyment during summer heat or athletic activity.

2. Description of the Related Art

During summer months or at times of prolonged exercise, cooled drinking fluids are preferred. General methods of cooling fluids for drinking involve three approaches: placing the fluid of interest into a refrigerator; or, placing the fluid of interest in a plastic drink bottle in a freezer unit of a refrigerator; or, adding ice or ice equivalents to the drinking fluid. All three methods have inherent weaknesses. Fluids cooled in a standard refrigerator generally return to room temperature within one hour (depending on specific atmosphereic conditions). Fluids placed in a freezer are generally not available for consumption until a significant amount of the fluid has thawed. At that time, the fluid composition (and taste) has changed due to the uneven thawing of fluid components. And finally, adding ice to a fluid is not always possible for small-neck bottles, and the added ice inherently dilutes the original drinking fluid and makes it less appealing. There are water bottles that sport an undrinkable “freezer stick” that may be frozen prior to its addition to the contents of the water bottle. The problem with said freezer sticks is that they do not cool fluids well (due to their necessarily small size) and they take up precious volume with material that is not consumed by a user. The material in the freezer stick (water and gel) reduces the volume of available fluids in a fixed bottle volume. This weakness and that of its poor cooling characteristics for room temperature drinks make for a unsatisfactory fluid cooling system.

### SUMMARY OF INVENTION

The present invention offers a method for providing minimally two drinking fluids in a single beverage container. The container, generally realized as a drink bottle, may be used for successful, dilution-free cooling of a drinking fluid.

The present invention provides for a plastic drink bottle having two closed internal compartments, the closed internal compartments being able to hold a first drinking fluid and a second drinking fluid, such that a user may access the first drinking fluid independent of said second drinking fluid.

In one aspect of the invention, each closed internal compartment has an external cap.

In another aspect of the invention, the closed internal compartments are filled with a first drinking fluid and a second drinking fluid after manufacture and prior to sale.

In an additional aspect of the invention, joining of the separate closed internal compartments is performed by a user who may select closed internal compartments containing different drinking fluids.

In still another aspect of the invention, the closed internal compartments are manufactured with protrusions and indentations on one side of the closed internal compartments. By placing the protrusions of one closed internal compartment into the indentations of another closed internal compartment, one may form a single plastic drink bottle.

In yet another aspect of the invention, the volume and shape of the closed internal compartments as well as the surface area between them are optimized for cooling of a drinking fluid added to one of the closed internal compartments through this fluid's proximity to a frozen drinking fluid in a second closed internal compartment. The closed internal compartments may be of different volumes and shapes and may interlock to form a single plastic drink bottle.

In an additional aspect of the invention, the closed internal compartments are separated by a plastic separator that runs the entire height of the plastic drink bottle. The thickness of the separator may be modified during bottle production to modulate the rate of heat transfer between drinking fluids in the separate closed internal compartments.

The invention additionally includes a method for cooling a drinking fluid, including the steps of preparing minimally two closed internal compartments able to receive drinking fluids; filling a first closed internal compartment with a drinking fluid and closing said internal compartment with a cap; placing said first closed internal compartment with drinking fluid into a freezer for a period of time that allows for freezing of the drinking fluid in the first closed internal compartment; removing said first closed internal compartment from the freezer; adding a second drinking fluid to a second closed internal compartment such that the second drinking fluid is in non-contact proximity to frozen first drinking fluid.

One aspect of the method has water as the drinking fluid added to the first closed internal compartment.

Another aspect of the method has a separate external cap associated with each closed internal compartment.

The invention also includes a disposable drinking bottle having two closed internal compartments manufactured separately and joined together to form a single disposable drinking bottle. The disposable drinking bottle includes either two external caps or one internal cap that allows for user-controlled access to drinking fluids in one or both of the closed internal compartments.

One aspect of the invention has the separately manufactured closed internal compartments being joined together prior to addition of drinking fluids to the closed internal compartments.

One further aspect of the invention has the separately manufactured closed internal compartments being joined together after addition of drinking fluids to the closed internal compartments.

### BRIEF DESCRIPTION OF THE DRAWINGS

FIG. 1 is a picture of a development prototype of the present invention.

FIG. 2 shows an schematic view of a preferred embodiment of a plastic drink bottle according to the present invention.

FIG. 3 shows an alternative schematic view of a disposable drink bottle according to the present invention. In this embodiment, the two closed internal compartments are side by side and a single cap allows for access to fluid contents of one or both closed internal compartments.

FIG. 4 shows a schematic view of an alternative preferred embodiment of the present invention in which closed internal compartments are produced separately and assembled for a final plastic drink bottle.

FIG. 5 shows a schematic view of an alternative preferred embodiment of the present invention in which closed internal compartments are produced separately with caps and filled with drinking fluids before being joined together to form a final plastic drink bottle.

FIG. 6 shows a schematic view of an alternative preferred embodiment of the present invention in which closed internal compartments from carton are produced for a disposable drink bottle for milk-based products.

FIG. 7 shows a schematic view of an alternative embodiment of the present invention in which closed internal compartments are separated by a spacer.

### DESCRIPTION OF THE PREFERRED EMBODIMENT

In the following description, numerous specific details are set forth in order to provide a thorough understanding of the present invention. It will be apparent, however, to one skilled in the art that the present invention may be practiced without these specific details. In other instances alternative materials such as glass, carton or metal may be employed in the present invention. The unique aspect of the invention, independent of material or specific drinking fluid, is an arrangement of two closed internal compartments that may hold the same or different drinking fluids. Fluid in one closed internal compartment may be frozen so as to cool the drinking fluid in a second closed internal compartment. When the frozen fluid has defrosted, it too may be imbibed so as to get maximal cooling and urer benefit from the volume of the plastic drink bottle.

### Definitions.

Certain terms are now defined in order to facilitate better understanding of the present invention.

A “plastic drink bottle” refers to a container made of plastic that can both hold a drinking fluid and be opened and closed by a user. A plastic drink bottle may be sold with one or more unique drinking fluids in associated closed internal compartments. After use, the plastic drink bottle may be recycled or used for cooling of drinking fluid as described herewith.

A “disposable drink bottle” for the present invention refers to a drink bottle composed of two or more closed internal compartments and is filled with one or more drinking fluids for sale to a user. A disposable drink bottle is produced by a manufacturer for single use prior to disposal or recycling. A “plastic drink bottle” may also be a “disposable drink bottle” if it is prepared from plastic and sold with drinking fluids present in the bottle at time of sale.

“Drink bottle” when used alone refers to either a plastic drink bottle or a disposable drink bottle.

“Fluid” or “drinking fluid” refers to any liquid beverage that may be imbibed. Water, fruit juices, milk and carbonated soft drinks are some non-limiting examples of drinking fluids. Drinking fluids in a plastic drink bottle or disposable drink bottle reside in minimally two closed internal compartments. “Drinking fluids” for the present invention are generally non-alcoholic beverages.

“Freezer” and “refrigerator” have their normal meaning in the art.

“Closed internal compartment” refers to a portion of a plastic drink bottle or disposable drink bottle according to the present invention, said portion representing a drinking fluid container that is a proximate to a second internal compartment of the same drink bottle (they may share a separator wall). Specifically, a “closed internal compartment” is a spatial element (of any shape or volume) capable of holding a drinking fluid alone, without fluid contact from drinking fluid in another closed internal compartment. Drinking fluid in one closed internal compartment may be frozen in a freezer or freezer unit of a refrigerator prior to addition of drinking fluid to a second closed internal compartment of the same plastic drink bottle. The closed internal compartments of a single bottle may be manufactured separately and then joined together. In such a case, the separate closed internal compartments may be joined during manufacture prior to sale of drink bottle or they may filled with drinking fluids and then joined together by user (and are thus sold as separate elements).

“Joining” or “joining together” of closed internal compartments refers to the process of combining two or more separate closed internal compartments to form a single plastic drink bottle or disposable drink bottle. Joining may be performed by physical attachment, gluing, interlocking or other means of associating distinct closed internal compartments into a single drink bottle.

“Internal cap” refers to a type of cap for a plastic drink bottle according to the present invention. The specific shape of the internal cap and its placement on a plastic drink bottle is the subject of a separate design patent filing. In general, the internal cap sits above the openings of the closed internal compartments and has a shape that allows for its movement or rotation so as to expose the opening of one closed internal compartment while closing off the openings of all other closed internal compartments of the same drink bottle. The internal cap may be placed in such a position that both closed internal compartments may be accessed (the internal cap covers half of the opening of each of the two closed internal compartments). The internal cap may be moved manually between the openings of internal compartments or may be rotated between the openings of the closed internal compartments.

“Cap” or “External cap” refers to a cap for a plastic drink bottle according to the present invention, said cap closing a drink bottle or a closed internal compartment completely. A cap or external cap may be associated with one closed internal compartment of a plastic drink bottle. Opening of cap allows for access to drinking fluid in closed internal compartment. The external cap may have a nipple to allow a user to drink directly from a plastic drink bottle. The external cap may have an “internal cap” as an integral part of the external cap construction.

“Nipple” for the present invention refers to a protrusion from an external cap, said protrusion allowing for direct user drinking of drinking fluids in plastic drink bottle or disposable drink bottle associated with said external cap and nipple.

“User” is a person who may purchase a plastic drink bottle and/or imbibe drinking fluids located in drink bottle closed internal compartments.

“Plastic” with respect to a drinking bottle refers to any polymeric material used in the construction of containers that hold drinking fluids. “Plastic” may refer to combinations of various organic materials used in the preparation of containers routinely used to hold water, soft drinks, natural juices and the like.

“Proximity” in the present invention refers to the position of drinking fluids relative to each other in distinct closed internal compartments. Proximity allows frozen fluid of a first closed internal compartment to cool drinking fluid of a second closed internal compartment, while warmer drinking fluid in the second closed internal compartment may thaw frozen drinking fluid in the first closed internal compartment. The thickness of the “separator” between fluids in closed internal compartments may be adjusted to modulate the speed of cooling/defrosting of fluid contents of a closed internal compartment. Closed internal compartments do not need to be adjacent to one another for disposable drink bottles.

“Period of time” refers to the time required for a drinking fluid in a closed internal compartment to freeze and depends on the freezer employed as well as atmospheric conditions present in place of use of the present invention. Generally, the period of time required to freeze or significantly cool several hundred milliliters of an aqueous drinking fluid in a closed internal compartment is three hours or longer.

Without being bound by any particular theory, the following discussion is offered to facilitate understanding of the invention. The plastic drink bottle assembly described herewith offers rapid, long-term cooling of drinking fluids without loss of composition or dilution of drinking fluid. The bottle utilizes a novel method of providing for two closed internal compartments with drinking fluids such that freezing of drinking fluid in one closed internal compartment allows for cooling of drinking fluid in a second closed internal compartment. The advantages of the present invention include the ability to have two unique fluids available to a user at one time (independent of any cooling), as well as the option of having cold drinks available for an extended period of time. This latter outcome is due to a frozen first drinking fluid in one closed internal compartment cooling a second drinking fluid, while said second drinking fluid warms up the frozen first fluid to make the latter fluid also available for drinking. The combination of two (or more) closed internal compartments into one plastic drink bottle allows for maximal drink benefit without loss of volume to the contents of unconsumed freezer sticks or similar cooling elements. The two drinking fluids as used in the present invention may combine for 2 or more hours of cold beverage availability.

A plastic drink bottle according to the present invention may be prepared as a single bottle with two closed internal compartments, or alternatively as two closed internal compartments that may be joined after manufacture to form a single plastic drink bottle. Cleaning of a plastic drink bottle allows for its possible reuse. A user may add any drinking fluid to either closed internal compartment to allow for enjoyment of different drinking fluids alone or in combination. Alternatively, he/she may freeze drinking fluid in one closed internal compartment for cooling of a second drinking fluid in a second closed internal compartment. Manufacture of closed internal compartments could include small protrusions and indentations on one side of the closed internal compartments. Placing protrusions of a first closed internal compartment into indentations of a second closed internal compartment (like joining Lego blocks) allows for formation of a single plastic drink bottle from two closed internal compartments.

### Embodiments

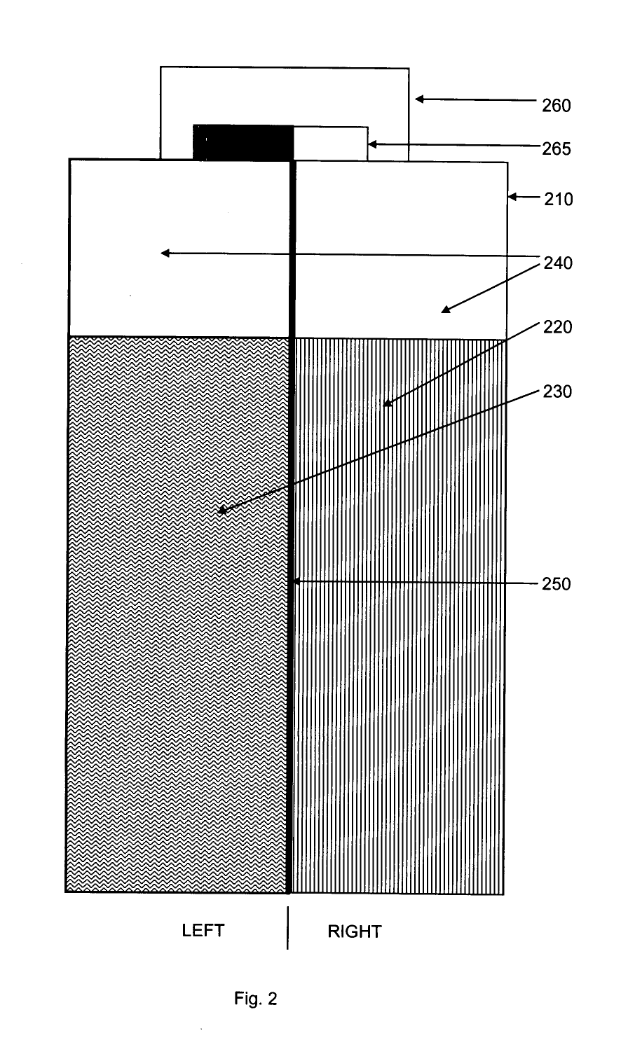

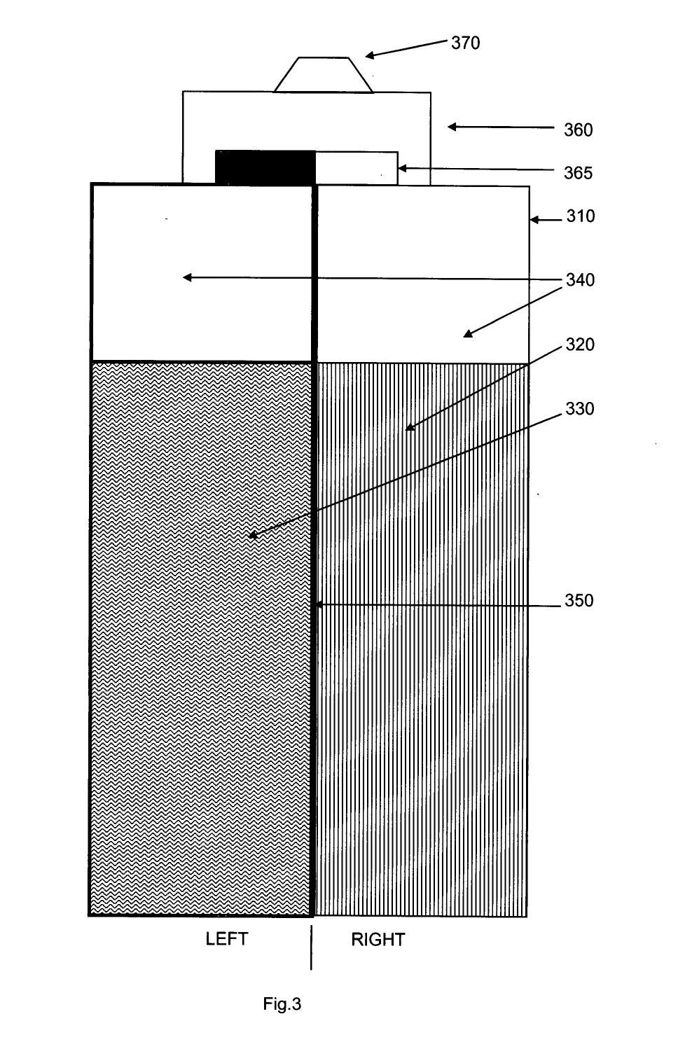

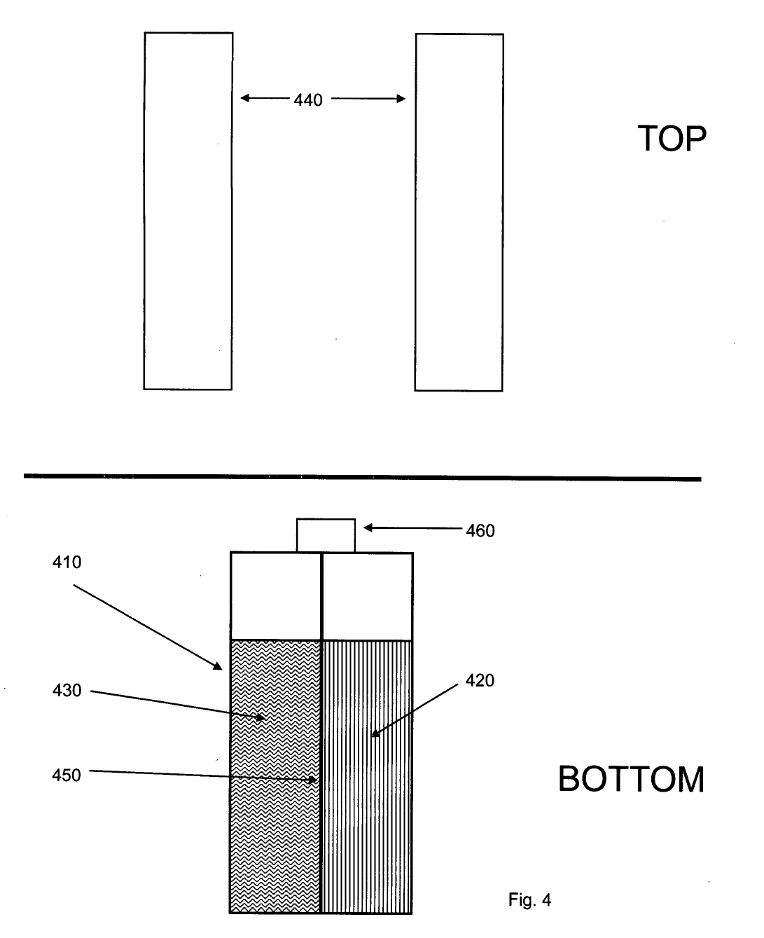

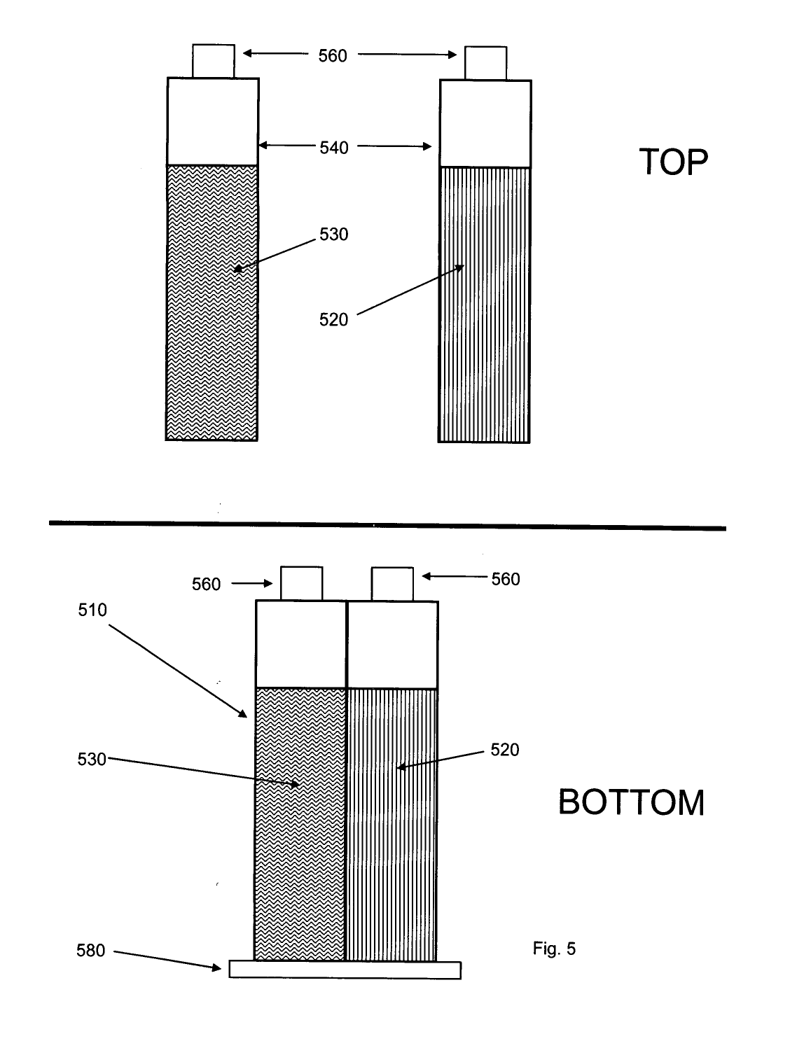

In the figures associated with the description below, the drinking fluids do not reach the top of the bottle only for ease of numbering of the various elements in the invention. As envisioned in the present invention, drinking fluids in the closed internal compartments can reach the top of the closed internal compartments. A drink bottle according to the present invention minimally has two closed internal compartments. A plastic drink bottle according to the present invention may be made with closed internal compartments formed (FIG. 2 and FIG. 3) during manufacture of drink bottle. Alternatively, the closed internal compartments may be manufactured separately and joined together at a later time either before or after addition of drinking fluids (FIG. 4 and FIG. 5). The closed internal compartments,when manufactured separately and joined at a later time, may be joined either by manufacturer, user or other entity.

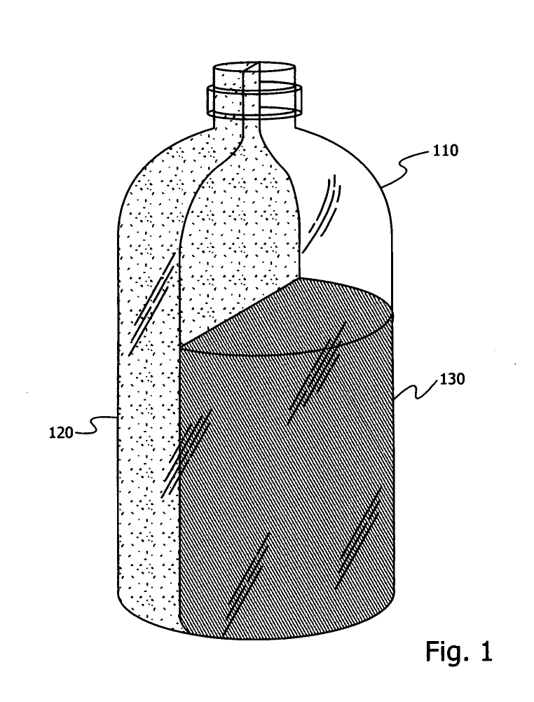

Reference is now made to FIG. 1, which shows a development prototype of the present invention. Plastic drink bottle (110) was provided. Said plastic drink bottle (110) was half-filled with drinking fluid (130) water, and the plastic drink bottle (110) was placed on its side in the freezer unit of a refrigerator (Magic Chef, Maytag, Chicago). After sitting in the freezer overnight, the plastic drink bottle (110) was removed with frozen drinking fluid (130) as seen on left side of bottle. A second drinking fluid (120, grape juice, Tapuzina, Israel) was added and was immediately cooled by the presence of frozen first drinking fluid (130). As this early prototype did not have a separator (see 250 in FIG. 2 and 350 in FIG. 3 below) defining closed internal compartments, the 500 milliliters of drinking fluid (130) water eventually thawed (over four hours) and significantly diluted drinking fluid (120) which then became less enjoyable to imbibe.

Reference is now made to FIG. 2, which is a schematic representation of a preferred embodiment of the present invention. A plastic drink bottle (210) with an external cap (260) has an internal cap (265) that may close one of two closed internal compartments (240) containing drinking fluids (220, 230). A plastic separator (259) separates the two closed internal compartments (240). The advantage of this preferred embodiment is several fold. Firstly, one can add fluid (230) to one closed internal compartment (240, LEFT) without prefilling the second closed internal compartment (240, RIGHT). Additionally, one can drink either drinking fluid (220, 230) in the closed internal compartments (240) by rotating or moving the internal cap (265) and thus access the full contents of the plastic drink bottle (210). There is no volume loss to non-potable drinking elements. The cap (260) and the internal cap (265) may be a single element and are shown as distinct elements for convenience only. The internal cap (265) sits at the openings of the closed internal compartments (240) and may be rotated or manually moved to close (black color 265) one of the two closed internal compartments (240), thus exposing the other closed internal compartment (240). The cap (260) seals the bottle completely. For use of this embodiment for liquid cooling, user would add drinking fluid (230) to one closed internal compartment (240) and then close this closed internal compartment (240, LEFT) with the internal cap (265). The plastic drink bottle (210) would then be placed in a freezer. When the fluid (230) in the closed internal compartment (240) had frozen, said plastic drink bottle (210) would be removed from freezer and drinking fluid (220) would be added to the second closed internal compartment (240, RIGHT). The cap (260) would then be closed. A user would have immediate access to cold drinking fluid (220) and after the drinking fluid (230) in the closed internal compartment (240, LEFT) has defrosted he/she may rotate the internal cap (265) and drink this fluid (230) as well. Alternatively, one may add different drinking fluids (220, 230) to the two closed internal compartments (240) and imbibe them either together (internal cap [265] rotated to partially exposed openings of both closed internal compartment) or separately.

In the preferred embodiment shown in FIG. 2, the two closed internal compartments are shown as equal sized. In point of fact, they may be of any size or shape, and they may be placed either side-by-side or with one closed internal compartment surrounded by the other closed internal compartment (not shown).

FIG. 3 shows a preferred embodiment of a disposable drink bottle (310) having two closed internal compartments (340), each filled with a unique drinking fluid (320, 330) and separated by a separator (350). An internal cap (365) sitting at the opening of the closed internal compartments (340) allows for selective access to contents of one or both closed internal compartments (340), while external cap (360) with nipple (370) allows for both full closure of disposable drink bottle (310) as well as direct imbibing of either drinking fluid (320 or 330) from said disposable drink bottle (310). In the preferred embodiment of FIG. 3 the internal cap (365) is open for the right closed internal compartment (340) while being closed (shown as black) for the left closed internal compartment (340).

FIG. 4 shows an alternative preferred embodiment of the present invention. Closed internal compartments (440) are prepared separately (TOP of figure). Each closed internal compartment (440) may hold a unique drinking fluid. For construction of a single plastic drink bottle (410), the two closed internal compartments (440) are joined (BOTTOM of figure) together. The separate closed internal compartments may be joined together either by any means. When the closed internal compartments are manufactured separately as in this preferred embodiment, a separator (450) is formed by sides of the closed internal compartments that directly contact one another. In this embodiment, external cap (460) closes the openings of the closed internal compartments (440). Drinking fluids (420, 430) are added to closed internal compartments (440) after the closed internal compartments (440) have been joined (BOTTOM of figure).

FIG. 5 shows an alternative preferred embodiment of a disposable drink bottle. Closed internal compartments (540) are manufactured separately, each with its own cap (560) (TOP of figure). Each closed internal compartment (540) holds a unique drinking fluid (530 and 520). For use, the two closed internal compartments (540) are joined (BOTTOM of figure) for formation of a single plastic drink bottle (510) with two distinct caps (560). The separate closed internal compartments (540) may be held together by any means including but not limited to gluing or interlocking of closed internal compartments (540). An option base element (580) might be used to hold closed internal compartments (540) in place.

The inherent efficacy of the present invention may be explained as follows:

(1) that by isolating drinking fluids in distinct closed internal compartments, one allows users to express their unique taste in beverages in a single beverage container;

(2) that by freezing a fluid in a first closed internal compartment one allows for cooling of drinking fluid in a second adjacent closed internal compartment. The result is access to cold drinking fluids for an extended period of time measured in the hours;

(3) that by freezing only the fluid in the closed internal compartment and not the adjacent drinking fluid, one prevents dilution and degradation of drinking fluid; and

(4) that said plastic drink bottle allows both vendors and users to make unique combinations of drinks for sale or use. A vendor might have cola in one closed internal compartment and frozen water in a second closed internal compartment, while a user might clean and reuse the same plastic drink bottle with apple juice in one closed internal compartment and orange juice in a second closed internal compartment.

### EXAMPLE 1

An empty 500 milliliter plastic drink bottle (210) with two 250 milliliter closed drinking compartments (240) separated by a plastic separator (250) is purchased. User adds water as drinking fluid (230) to a first internal compartment (240, LEFT). He/she closes said closed internal compartment (240) with an internal cap (265) and then closes the plastic drink bottle (210) with external cap (260). The plastic drink bottle (210) is placed in a freezer for three hours at which time drinking fluid (230) has frozen. User adds drinking fluid (220) to a second closed internal compartment (240, RIGHT). The drinking fluid (240) is immediately cooled by the frozen drinking fluid (230) in the adjacent closed internal compartment (240, LEFT). When user has finished imbibing the drinking fluid (220), he/she may rotate the internal cap (265) to access the thawed drinking fluid (230) in the first closed internal compartment (240, LEFT). The user has benefited from both cooling of drinking fluid (220) and maximal drinking fluids (220 and 230 combined) available.

### EXAMPLE 2

A 1000 milliliter disposable drink bottle (310) is produced from paper carton with two 500 milliliter closed internal compartments (340) side by side in the disposable drink bottle (310) that includes a nipple (370) attached to a cap (360). A separator (350) separates the two closed internal compartments (340). A manufacturer places milk as drinking fluid (330) in a first closed internal compartment (340, LEFT) and chocolate milk as drinking fluid (320) in a second closed internal compartment (340, RIGHT). An internal cap (365) keeps one closed internal compartment (340, LEFT) closed while keeping the second closed internal compartment (340, RIGHT) open. An external cap (360) seals the disposable drinking bottle (310) completely. A user may move the internal cap (365) to choose which drinking fluid (320, 330) he/she wishes to imbibe directly from the disposable drink bottle (310) by way of cap (360) and associated nipple (370).

### EXAMPLE 3

500 milliliter plastic closed internal compartments (540) are produced separately and filled with either water drinking fluid (530) or cola drinking fluid (540). The closed internal compartment (540) with water drinking fluid (530) is placed in a freezer. A user selects closed internal compartment (540) with frozen water drinking fluid (530) and manually joins it together with closed internal compartment (540) with room-temperature cola drinking fluid (520). The user joins the two closed internal compartments through the agency of a protrusions and indentations in the plastic closed internal compartments (not shown) to form a single plastic drinking bottle (510).

Cost of manufacture for the present invention is low as production, filling and sealing of the closed internal compartment requires no new technology in the manufacture of drink bottles or component closed internal compartments.

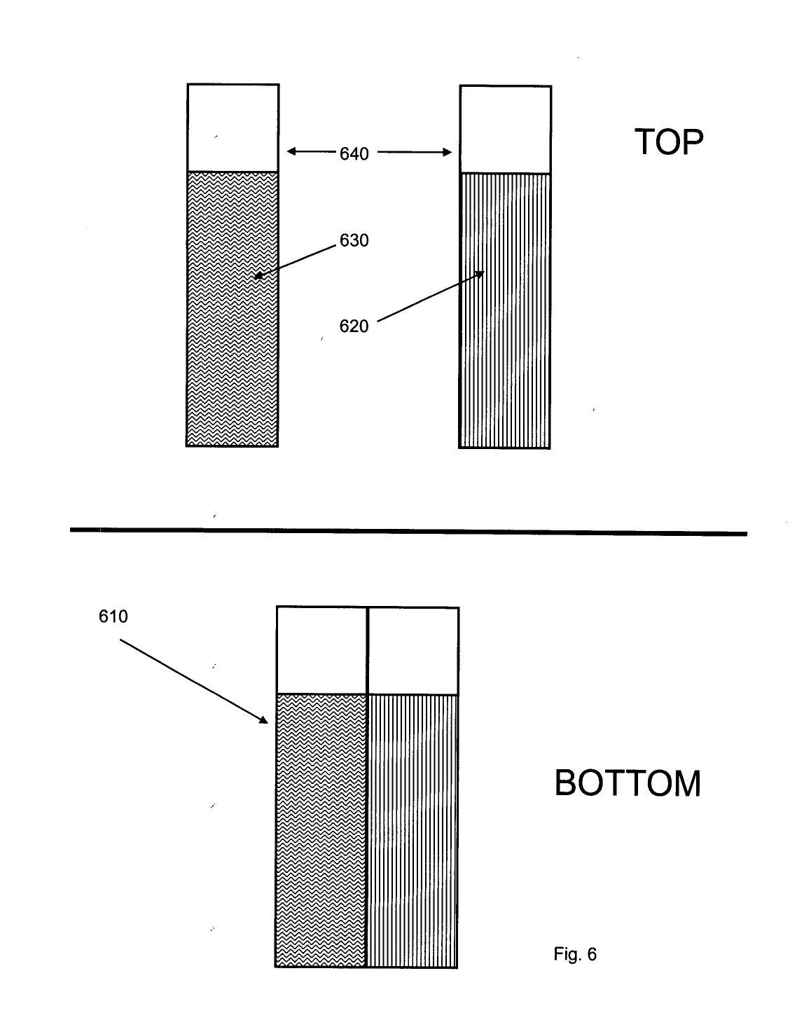

The present invention has been described with a certain degree of particularity, however those versed in the art will readily appreciate that various modifications and alterations may be carried out without departing from the spirit and scope of the following claims. Therefore, the embodiments and examples described here are in no means intended to limit the scope or spirit of the methodology and associated devices related to the present invention. The drink bottles and closed internal compartments described in the present invention may be of any size, shape and material. Other drink holding items such as water backpacks may also be prepared according to the present invention with the one proviso that there is no direct fluid-fluid contact between drinking fluids present in the two (or more) closed internal compartments. Since any drinking fluids may be added to a closed internal compartment, users will have the ability to choose their favorite drinks to take along with them. By reusing the bottle, significantly fewer disposable bottles will need to be produced on an annual basis. Beverage bottles made from paper carton such as those routinely employed for milk and milk products are also appropriate for the present invention. Referring to FIG. 6, carton closed internal compartments (640) are produced and filled with milk drinking fluid (620) and chocolate milk drinking fluid (630) (TOP of FIG. 6) and are then glued together to form disposable drink bottle (610) that has no external or internal caps as carton drink containers are often opened manually by user to expose milk-based beverages including liquid yogurts.

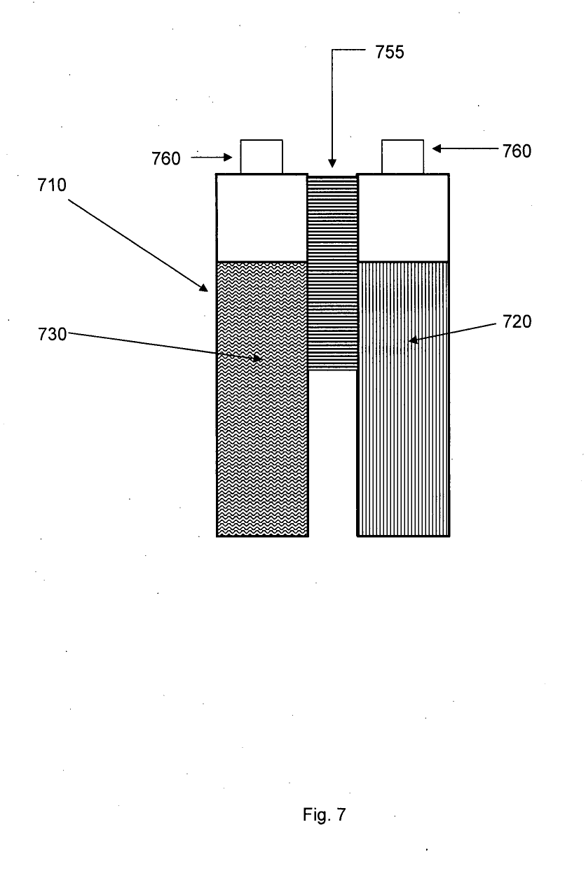

The drink bottle described herewith has been shown with closed internal compartments immediately adjacent one to another. In a case where there is no interest in cooling one drinking fluid through the presence of another frozen drinking fluid, one can have a physical separation of closed internal compartments as shown in FIG. 7. Closed internal compartments (740) holding drinking fluids (720, 730) are separated by a spacer (755) in disposable drink bottle (710) sporting two external caps (760).

The method and device described herewith have application to both hard-plastic and soft-plastic drink bottles. Polycarbonate, low-density polyethylene (LDPE), high-density polyethylene (HDPE), polyethylene terephalate (PET), polypropylene, and polystyrene are non-limiting examples of plastics that are amenable for use in the present invention. The present invention may contribute to a significant reduction in the production of disposable drink bottles. Reuse and recombination of closed internal compartments will lead to fewer disposable drink bottles being discarded to the environment on a yearly basis.

1. A plastic drink bottle having two closed internal compartments, said closed internal compartments being able to hold a first drinking fluid and a second drinking fluid, such that a user may access said first drinking fluid independent of said second drinking fluid.

2. The plastic drink bottle according to claim 1, wherein each closed internal compartment has an external cap.

3. The plastic drink bottle according to claim 1, wherein said closed internal compartments are filled with said first drinking fluid and said second drinking fluid prior to sale.

4. The plastic drink bottle according to claim 1, wherein said closed internal compartments are manufactured with protrusions and indentations on one side of said closed internal compartments.

5. The plastic drink bottle according to claim 1, wherein the volume and shape of said plastic drink bottle as well as the surface area between said closed internal compartments are optimized for cooling of a drinking fluid added to one of said closed internal compartment of said plastic drink bottle.

6. The plastic drink bottle according to claim 1, wherein said closed internal compartments are separated by a separator that runs the entire height of the plastic drink bottle.

7. A method for providing cooled drinking fluid for an extended period of time, including the steps of:
Preparing two closed internal compartments, each closed internal compartment being able to receive a drinking fluid;
Filling a first closed internal compartment with a drinking fluid and closing said internal compartment with a cap;
Placing said first closed internal compartment with drinking fluid into a freezer for a period of time that allows for freezing of said drinking fluid in said first closed internal compartment;
Removing said first closed internal compartment from said freezer;
Adding a second drinking fluid to a second closed internal compartment, such that said second drinking fluid is in non-contact proximity to frozen first drinking fluid.

8. The method according to claim 7, wherein said drinking fluid added to said first internal compartment is water.

9. The method according to claim 7, wherein said closed internal compartments have separate external caps.

10. A disposable drinking bottle, said disposable drinking bottle having two closed internal compartments manufactured separately and then joined together to form a single disposable drinking bottle.

11. The disposable drinking bottle according to claim 10 wherein said disposable drinking bottle includes two external caps.

12. The disposable drinking bottle according to claim 10 wherein the separately manufactured closed internal compartments are joined together after addition of drinking fluids to said closed internal compartments.
